(19) United States
(12) Patent Application Publication
(10) Pub. No.: US 2003/0037768 A1
(43) Pub. Date: Feb. 27, 2003

(54) Method, computer program, control and/or regulating unit, and fuel system for an internal combustion engine

(76) Inventors: Sebastian Kanne, Stuttgart (DE); Godehard Nentwig, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/214,489

(22) Filed: Aug. 8, 2002

(30) Foreign Application Priority Data
Aug. 8, 2001 (DE) 1 01 39 055.6

(51) Int. Cl. F02M 1/00

(52) U.S. Cl. 123/446; 123/458

(57) ABSTRACT

An internal combustion engine, in particular with direct injection, is operated according to a method in which a first fuel pump delivers fuel from a fuel tank. At least a part of the delivered fuel travels on via at least one inlet valve into at least one working chamber of a second fuel pump embodied as a positive-displacement pump. This second fuel pump delivers the fuel to a fuel accumulation line. In order to increase the efficiency during operation of the engine and to reduce costs, the invention proposes that the relative opening duration of the inlet valve be influenced in order to thus change the fuel quantity traveling into the working chamber (40) of the second fuel pump.

### BACKGROUND OF THE INVENTION

1. Field of the Invention

The current invention relates to a method for operating an internal combustion engine, in particular with direction injection, in which a first fuel pump delivers fuel from a fuel tank and in which at least a part of the delivered fuel travels on via at least one inlet valve into at least one working chamber of a second fuel pump embodied as a positive-displacement pump, which delivers the fuel to a fuel accumulation line.

2. Description of the Prior Art

A method is known from DE 199 26 308 A1 in which a presupply pump delivers the fuel from a fuel tank to a mechanically driven main delivery pump. The main delivery pump is a radial piston pump. This radial piston pump in turn delivers the fuel into a fuel accumulation line, which is also commonly referred to as a “rail” and in which the fuel is stored under high pressure. The fuel accumulation line is connected to injectors, which inject the fuel into combustion chambers of the engine.

If the engine only needs to produce a small amount of power, then the injectors need only inject a small amount of fuel into combustion chambers so that in addition, the main delivery pump need only deliver a small amount of fuel to the fuel accumulation line. With such a partial quantity delivery, in order to reduce the driving torque of the main delivery pump, a metering device is provided in the supply line to the working chamber of the main delivery pump. During a partial quantity delivery, this metering device throttles the influx into the working chamber of the main delivery pump so powerfully that the working chamber is only partially filled or is not filled at all. The metering device is usually an electrically controlled throttle valve that is built into the inlet of the main delivery pump.

This known embodiment is simple and inexpensive, but also has disadvantages: for example, it is necessary to be able to precisely adjust the throttle valve over a very large range in order to have the ability to produce an unlimited variety of desired delivery quantities. A throttle valve of this kind, however, is relatively expensive. Furthermore, with conventional throttle valves, even at full delivery—i.e. when the valve is completely open, the presence of the valve causes the pressure to drop by a certain pressure differential. If additional pressure losses occur upstream of the main delivery pump and when there is a high return pressure, then the adjustment range between zero-delivery and full delivery is considerably reduced.

### OBJECT AND SUMMARY OF THE INVENTION

The object of the current invention, therefore, is to modify a method of the type mentioned above so that the internal combustion engine operated with the method, in particular its fuel system, is less expensive to produce and can be operated with a higher efficiency.

This object is attained with a method of the type mentioned above in that the relative opening duration of the inlet valve is changed in order to thus change the fuel quantity traveling into the working chamber of the second fuel pump.

A significant advantage of the invention is that a throttle valve in the inlet of the second fuel pump can be eliminated, which results in a cost reduction. Instead, the fuel quantity supplied by the second fuel pump is adjusted by changing the relative opening duration of the inlet valve into the working chamber of the second fuel pump. Depending on the opening duration, more or less fuel travels into the working chamber of the fuel pump, which results in a corresponding delivery quantity. The relative opening duration of the inlet valve is not understood to be an absolute time value, but an opening time interval that relates to a speed. Since the method according to the invention no longer requires a throttle restriction in the inlet to the second fuel pump, the engine and in particular its fuel system can be operated with a favorable degree of efficiency.

For example, the invention proposes that the relative opening duration of the inlet valve be hydraulically influenced. This makes it possible to use a relatively compact second fuel pump since a hydraulic actuation of the inlet valve can be realized in a more space-saving manner than an electrical actuation, for example. In principle, however, it is also conceivable to use an inlet valve that is electrically actuated, for example by means of a piezoelectric actuator or magnetic actuator.

If the inlet valve is hydraulically actuated, it is particularly preferable if the relative opening duration of the inlet valve is influenced by changing a control pressure acting on a control surface of a valve element of the inlet valve. A method of this kind functions in a reliable, highly dynamic fashion.

A particularly preferable modification of the method according to the invention proposes that in order to achieve a zero-delivery, the inlet valve is open during the entire delivery stroke. A zero-delivery can be required, for example, when the engine is being overrun, and no fuel from the fuel accumulation line is required. In this instance, no delivery into the fuel accumulation line is required either. Because the inlet valve is open during the entire delivery stroke, the fuel quantity that has traveled into the working chamber during the intake stroke is not delivered to the fuel accumulation line, but is shunted back into the inlet region of the second fuel pump.

This permits the option of eliminating an external lubrication of the moving parts of the second fuel pump since even with long-term operation at zero-delivery, there is no danger of these moving drive means and delivery means running dry. There is also no danger of cavitation erosion in the vicinity of the working chamber of the second fuel pump. If the engine is operated according to this method, a long service life of the second fuel pump can be expected.

It is also advantageous if the desired driving torque of the engine is at least indirectly used to determine a reference opening duration of the inlet valve of the second fuel pump and/or a reference control pressure. This modification of the method according to the invention takes into account the fact that the fuel requirements of the engine depend to a significant degree on the desired driving torque of the engine. With the method according to the invention, it is possible to react extremely rapidly to changes in the desired driving torque, thus reducing the danger of the delivery of fuel into the fuel accumulation line, which is not actually required by the injectors connected to the fuel accumulation line. A pressure control valve, which is disposed in the fuel accumulation line, can either turn out to be smaller or can be completely eliminated.

The invention also relates to a computer program, which is suitable for executing the above method, when it is run on a computer. It is particularly preferable if the computer program is stored in a memory, in particular a flash memory.

The invention also relates to a control and/or regulating unit for controlling and/or regulating at least one function of an internal combustion engine. In order to increase the efficiency during operation of the engine and possibly to extend the service life of individual components of the engine, the invention proposes that the control and/or regulating unit be provided with a computer program of the type mentioned above.

The invention also relates to a fuel system for an internal combustion engine, in particular with direct injection, having a fuel tank, a first fuel pump that delivers from the fuel tank, and a second fuel pump embodied as a positive-displacement pump with at least one working chamber, which is connected on the inlet side via at least one inlet valve to the first fuel pump and is connected on the outlet the side to a fuel accumulation line.

This basic fuel system is also known from DE 199 26 308 A1. In order to improve the efficiency during operation of the fuel system and to reduce the production costs of the fuel system, the invention proposes that an influencing device be provided, which can influence the relative opening duration of the inlet valve. The advantages of such a fuel system have already been explained above in connection with the method according to the invention.

In a modification of this fuel system, the invention proposes that the second fuel pump include an inlet valve, which is embodied as a prestressed check valve whose valve element has an actuating section. An inlet valve of this kind is compact and can be simply actuated by means of the actuating section.

A particularly preferable modification is the one in which the influencing device includes a control pressure line, a pressure adjusting device that can adjust the pressure in the control pressure line, and a control chamber connected to the control pressure line, and in which the actuating section of the valve element of the inlet valve has a control surface that partially defines the control chamber. In this fuel system, therefore, the prestressed check valve can be hydraulically activated or overloaded so that its opening state can in fact be influenced on the one hand by the speed of the second fuel pump, but can also be influenced by the pressure in the control pressure line. An inlet valve of this kind opens and closes in a highly dynamic fashion and operates in a very reliable manner. In addition, an unlimited variety of delivery rates between zero-delivery and maximal delivery can be achieved with this kind of inlet valve.

In this connection, the invention proposes that the pressure adjusting device include an electrically adjustable metering valve, a return line that branches from the control pressure line between the metering valve and the control chamber, and a flow throttle that is disposed in the return line. Only the fluid quantity required for triggering the inlet valve flows through a metering valve of this kind. This is a small quantity of fluid. Consequently, the adjusting range of the metering valve can also be small. A metering valve of this kind is simple and inexpensive.

There are a number of advantageous possibilities for supplying the control pressure line: one is comprised in that the influencing device includes a fluid reservoir, which is disposed upstream of the metering valve and is connected to the control pressure line. A fluid reservoir of this kind can store the fluid, which is required to control the inlet valve, under high pressure so that the control surface on the actuating section of the valve element of the inlet valve can turn out to be relatively small. An inlet valve of this kind is therefore compact.

It is particularly advantageous that the fluid reservoir communicates with at least one hydraulically actuated injector in such a way that the reservoir is supplied by the cutoff fluid from the injector. Hydraulically actuated injectors are generally controlled by fuel, which is powerfully compressed by the second fuel pump. The cutoff fluid flowing out of the injector is consequently still under a relatively high pressure. In this modification, additional components for supplying the fluid reservoir can therefore be eliminated. The corresponding fuel system is therefore simply designed and inexpensive.

Alternatively, it is possible for the control surface on the actuating section of the valve element of the inlet valve to be larger than the effective surface area of the valve element and for the control pressure line to be connected to the outlet of the first fuel pump. The area ratios according to the invention permit a reliable actuation of the valve element of the inlet valve, even at the relatively low pressure produced by the first fuel pump.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a schematic representation of a first exemplary embodiment of a fuel system of an internal combustion engine, with a first and a second fuel pump, in which the second fuel pump is shown in a sectional view;

FIG. 2 shows a sectionally represented detail of a region of the second fuel pump from FIG. 1 and schematically depicted components of a device, which can influence the relative opening duration of an inlet valve of the second fuel pump;

FIG. 3 shows a graph in which the opening time interval of the inlet valve of the second fuel pump is depicted over the stroke of a piston of the second fuel pump, with a particular pressure in a control pressure line;

FIG. 4 shows a graph similar to FIG. 3, with a different pressure in the control pressure line;

FIG. 5 shows a graph similar to FIG. 3, with yet another pressure in the control pressure line; and

FIG. 6 shows a depiction similar to FIG. 2 of a region of a second exemplary embodiment of a fuel system.

### DESCRIPTION OF THE PREFERRED EMBODIMENTS

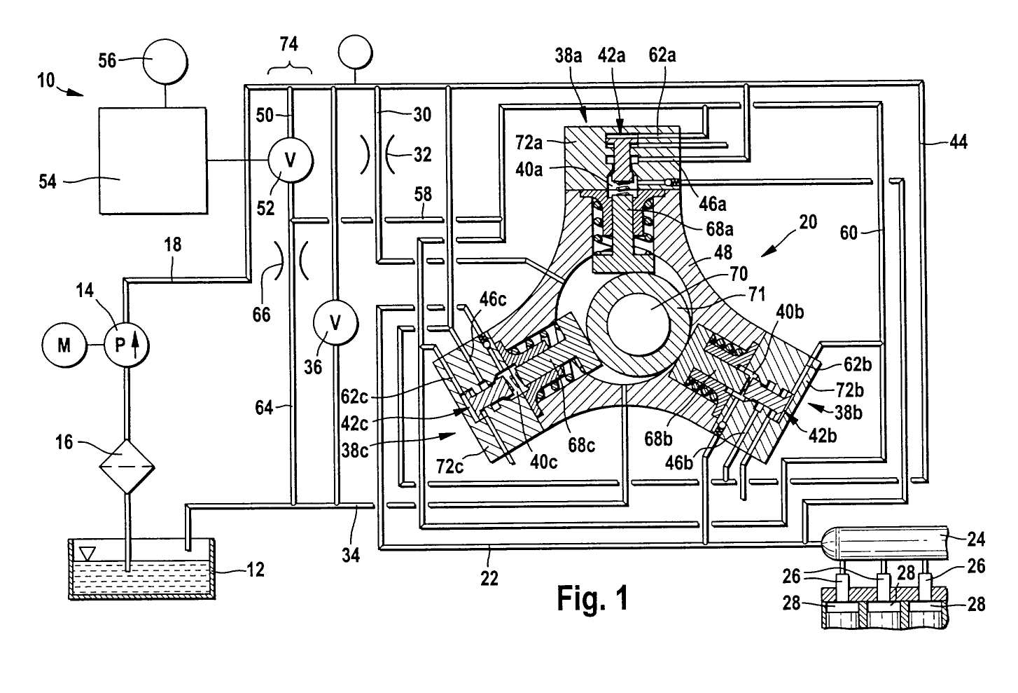

In FIG. 1, a fuel system is labeled as a whole with the reference numeral 10. It includes a fuel tank 12 from which an electric fuel pump 14 delivers fuel through a filter 16. The electric fuel pump 14 compresses the fuel to a pressure of approximately 5 bar. On the outlet side, electric fuel pump 14 is connected by means of a fuel line 18 to a high-pressure pump 20, which is embodied as a three-cylinder radial piston pump.

The radial piston pump 20 compresses the fuel further to a very high pressure (currently pressures of up to 1800 bar are achieved) and supplies this fuel via a fuel line 22 to a fuel accumulation line 24. This fuel accumulation line 24 is also commonly referred to as a “rail” and stores the fuel under high pressure. The fuel accumulation line 24 is connected to a number of injectors 26, which can inject the fuel into combustion chambers 28 of an internal combustion engine (not shown in detail).

A fuel line 30 branches from the low pressure fuel line 18 and supplies the radial piston pump 20 with fuel for cooling and lubrication. A flow throttle 32 is disposed in the fuel line 30. The fuel used for lubrication and cooling is discharged by the radial piston pump 20 by means of a fuel line 34, which leads back to the fuel tank 12. The pressure in the low-pressure fuel line 18 is adjusted by means of a pressure control valve 36, which is situated between the low-pressure fuel line 18 and the return line 34.

The three cylinders of the radial piston pump 20 are labeled with the reference numerals 38a, 38b, and 38c. They each contain a working chamber 40a, 40b, and 40c, which can be supplied with fuel by means of an inlet valve 42a, 42b, and 42c. To this end, the low-pressure fuel line 18 is connected to an annular line 44, from which an inlet conduit 46a, 46b, and 46c leads to the working chamber 40a, 40b, and 40c. For clarity in the depiction, the annular line 44 is only schematically represented in FIG. 1. It can, for example, be provided as an annular chamber in a housing 48 of the radial piston pump 20.

In order to trigger the inlet valves 42a, 42b, and 42c, a control pressure line 50 is provided, which branches from the low-pressure fuel line 18 and contains a metering valve 52. This metering valve is an electrically actuated sliding valve. It is connected to a control and regulating unit 54, which a sensor 56 supplies with information regarding the desired torque of the engine. On the outlet side of the metering valve 52, the control line 50 leads with a section 58 to an annular line 60 from which individual control conduits 62a, 62b, and 62c lead, each to an individual inlet valve 42a, 42b, and 42c. A throttle line 64 branches from the section 58 of the control pressure line 50, leads to the return line 34, and contains a flow throttle 66. The annular line 60 can also be provided in the form of an annular chamber in the housing 48 of the radial piston pump 20.

A piston 68a, 68b, and 68c is contained in sliding fashion in each cylinder 38a, 38b, and 38c of the radial piston pump 20. A camshaft 70 and a stroke ring 71 set the pistons 68a, 68b, and 68c into a reciprocating motion in the radial direction. The cylinders 38a, 38b, and 38c are closed in the radially outward direction by cylinder heads 72a, 72b, and 72c.

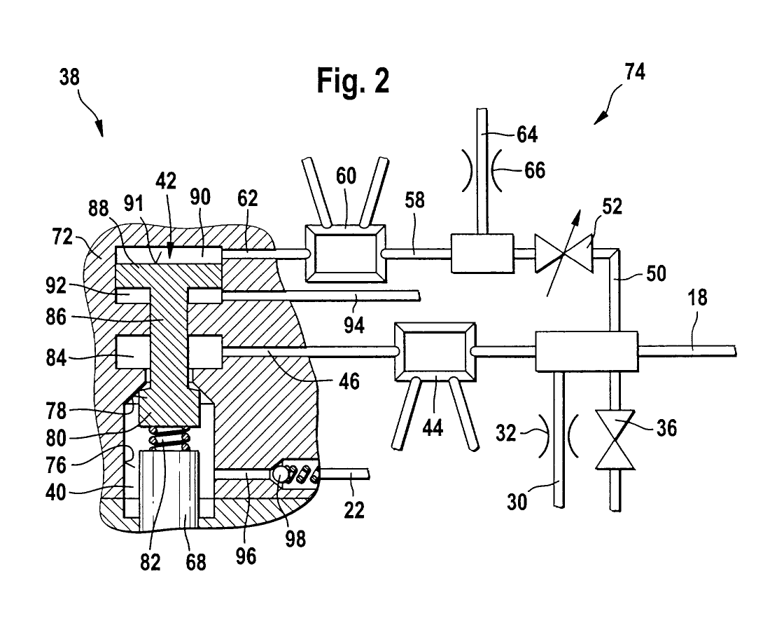

The control pressure line 50, the metering valve 52, the throttle line 64, and the flow throttle 66 are part of an influencing device 74, which can influence the relative opening duration of the inlet valves 42a, 42b, and 42c. This influencing device 74 will now be explained in detail, particularly with reference to FIG. 2. This Fig. shows one cylinder 38 as an example for the three cylinders 38a, 38b, and 38c of the radial piston pump 20.

The cylinder head 72 contains a step-shaped blind bore 76. Its lower region (unnumbered), which has a relatively large diameter, defines the working chamber 40. It tapers toward the top and in so doing, forms a valve seat 78 for a valve element 80 of the inlet valve 42. The valve element 80 is pushed against the valve seat 78 by a spring 82, which is supported on the piston 68 that protrudes into the working chamber 40 from below. Above the valve seat 78, there is an annular chamber 84 into which the inlet conduit 46 feeds.

The valve element 80 includes a cylindrical actuating section 86, which extends coaxial to the blind bore 76. It is supported in a sealed, sliding fashion in a region (unnumbered) of the blind bore 76 disposed above the annular chamber 84. At its upper end in FIG. 2, the actuating section 86 supports a control piston 88, whose diameter is considerably greater than the diameter of the valve element 80.

The control piston 88 is contained in a larger diameter region (unnumbered) of the blind bore 76 and on the one hand, defines a control chamber 90 with a control surface 91 and on the other hand, defines an overflow chamber 92. Even though this is not shown in FIG. 2, it goes without saying that the cylinder head 72 is designed so that the valve element 80, the actuating section 86, and the control piston 88 can be let into it. The control conduit 62 feeds into the control chamber 90, whereas the overflow chamber 92 is connected to an overflow line 94, which leads back to the fuel tank 12, for example. The working chamber 40 is connected to the high-pressure fuel line 22 by means of an outlet conduit 96 and a check valve 98.

The fuel system shown in FIGS. 1 and 2 functions as follows: If a high torque is to be produced by the engine, the injectors 26 inject a relatively large fuel quantity into the combustion chambers 28. Therefore the radial piston pump 20 must deliver a large fuel quantity into the fuel accumulation line 24 (the desired torque here is detected by the sensor 56). The control and regulating unit 54 then triggers the metering valve 52 so that it is completely closed. This results in the fact that the pressure in the section 58 of the control pressure line 50 approximately corresponds to the pressure in the throttle line 64.

Since this line leads back to the fuel tank 12, the pressure that prevails in the section 58 of the control pressure line 50 and consequently also in the control chamber 90 approximately corresponds to the ambient pressure. This in turn means that the opening behavior of the inlet valve 42 is essentially governed by the pressure difference between the annular chamber 84 and the working chamber 40 and by the force exerted by the spring 82. The inlet valve 42 here is designed so that the valve element 80 lifts up from the valve seat 78 shortly after the top dead center of the piston 68 and comes back into contact with this valve seat shortly after the bottom dead center of the piston 68.

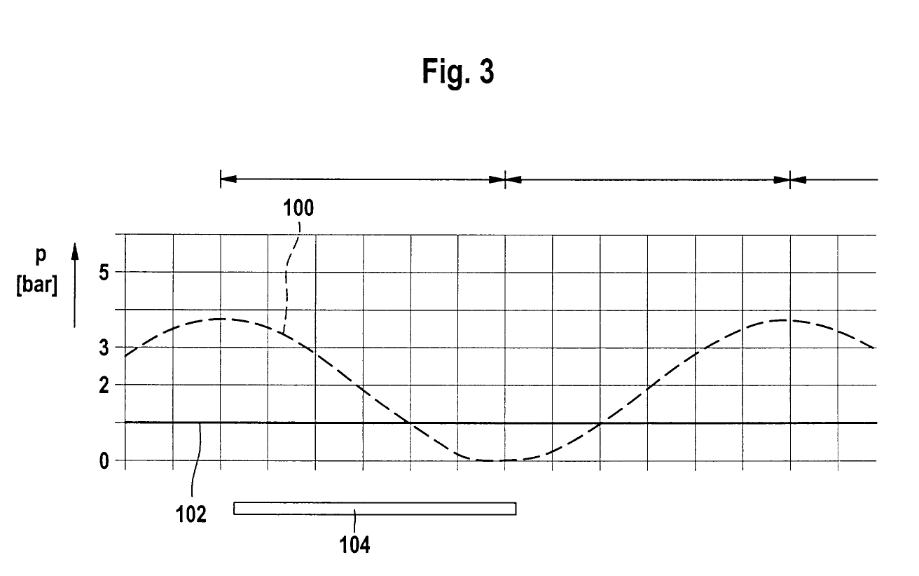

As is clear from FIG. 3, the inlet valve 42 is consequently open during approximately the entire intake stroke (reference numeral 104). The radial piston pump 20 consequently delivers the maximal possible fuel quantity. The curve in FIG. 3, which corresponds to the piston stroke, is labeled with the reference numeral 100; the pressure in the control chamber 90 is labeled with the reference numeral 102.

If a lower fuel quantity is to be delivered, the control and regulating unit 54 brings the metering valve 52 into a corresponding middle position. Depending on the opening state of the metering valve 52, the pressure in the section 58 of the control pressure line 50 and in the control chamber 90 assumes a value, which lies between the pressure prevailing in the throttle return line 34 and the pressure prevailing in the low-pressure fuel line 18. The metering valve 52 and the flow throttle 66 in the throttle line 64 namely function as a pressure distributing mechanism.

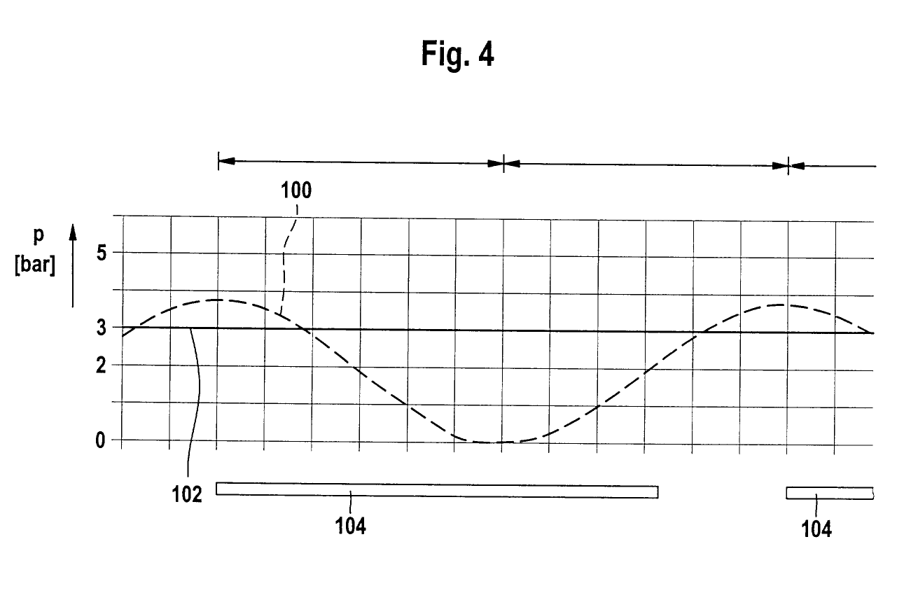

By means of the control surface 91 on the control piston 88, the pressure in the control chamber 90 exerts a force on the valve element 80. This causes the valve element 80, approximately at the top dead center of the piston 68, to come away from the valve seat 78, thus causing the inlet valve 42 to open. In contrast to the above-described instance, however, the valve element 80 is still kept open at the beginning of the delivery stroke, i.e. after the piston 68 has passed the bottom dead center, due to the pressure prevailing in the control chamber 90. Only when the pressure exerted by the spring 82 on the valve element 80 due to the upward motion of the piston 68 and the closing force acting on the valve element 80 due to the pressure difference between the annular chamber 84 and the working chamber 40 exceeds the opening force acting on the control piston 88 does the valve element 80 come back into contact with the valve seat 78. The inlet valve 42 is consequently open not only during the entire intake stroke, but also at the beginning of the delivery stroke. This is shown in FIG. 4.

However, if the inlet valve 42 is still open at the beginning of the delivery stroke, then a part of the fuel quantity aspirated into the working chamber 40 during the intake stroke is pushed back into the annular chamber 84 and the inlet conduit 46 at the beginning of the delivery stroke. Consequently, after the inlet valve 42 closes, there is only a small fuel quantity still remaining, which can be delivered into the fuel accumulation line 24.

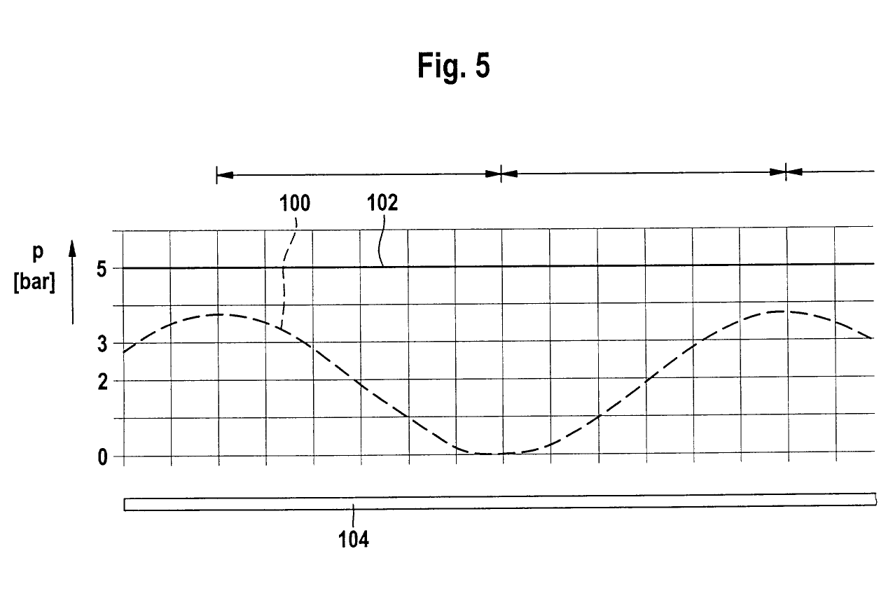

If the radial piston pump 20 should not deliver any fuel at all into the fuel accumulation line 24, then the control and regulating unit 54 opens the metering valve 52 completely. Consequently, the pressure, which is produced by the electric fuel pump 14 and prevails in the low-pressure fuel line 18, prevails in the control chamber 90. The size of the control surface 91 here is selected so that the opening force that the control piston 88 exerts on the valve element 80 via the actuating section 86 is always greater than the closing force exerted on the valve element 80 by the spring 82 and by the pressure difference between a working chamber 40 in the annular chamber 84. The inlet valve 42 is consequently also open during the entire delivery stroke, as shown in FIG. 5. Consequently, the entire fuel quantity that has traveled into the working chamber during the intake stroke is conveyed back into the low-pressure fuel line 18.

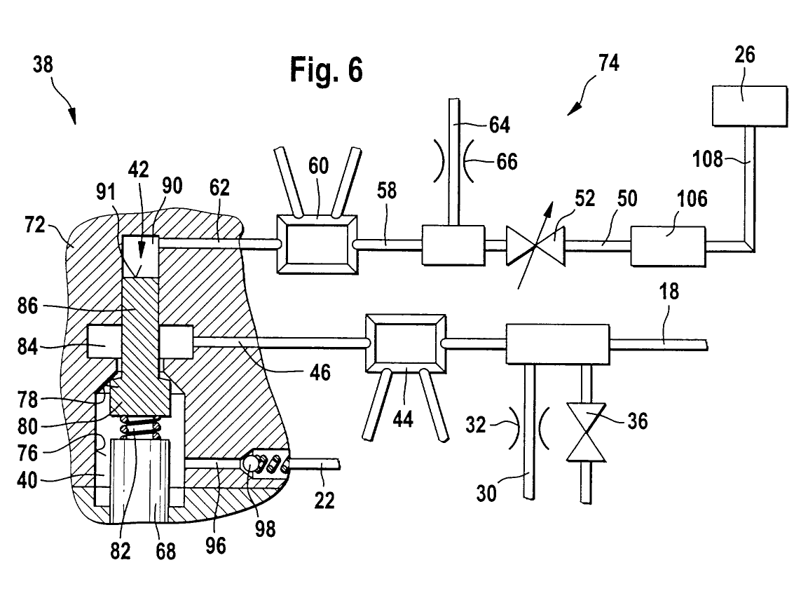

FIG. 6 shows a second exemplary embodiment of an influencing device 74. Elements and regions, which serve functions equivalent to elements and regions of the preceding exemplary embodiment are provided with the same reference numerals. They will not be discussed again in detail.

One essential difference from the preceding exemplary embodiment relates to the design of the actuating section 86 of the valve element 80 of the inlet valve 42. In the exemplary embodiment shown in FIG. 6, the control surface 91 is only relatively small; in any case, it is smaller than the effective surface area on the valve element 80 that is acted on by the pressure difference between the working chamber 40 and the annular chamber 84. A separate control piston is not provided. In this regard, there is also no overflow chamber and the control chamber 90 has smaller radial dimensions.

In order to be able to achieve the force in the opening direction required to reliably influence the opening duration of the inlet valve 42, the pressure in the control chamber 90 must be correspondingly high. For this reason, the control pressure line 50 is not connected to the outlet of the electric fuel pump 14; instead, a fluid reservoir 106 is provided, which supplies the control fluid to the control pressure line 50. The fluid reservoir 106 is in turn connected to a cutoff line 108, which is in turn connected to the cutoff outlet of an injector 26. In this manner, the fluid reservoir 106 is supplied with the relatively highly pressurized cutoff fluid from the injector 26. Typically, the pressure in the fluid reservoir 106 is approximately 15 bar.

The influencing device 74 shown in FIG. 6 functions in a manner analogous to the influencing device depicted in FIGS. 1 and 2. The smaller control surface 91 is compensated for by the production of a higher pressure in the control chamber 90. In both of the exemplary embodiments, the quantity of the fluid delivered by the radial piston pump 20 can be reduced to zero. The driving torque on the camshaft 70 of the radial piston pump 20 decreases considerably as delivery output falls (this also applies to the preceding exemplary embodiment).

It should also be noted at this point that a mechanical low-pressure pump can also be used instead of an electric fuel pump 14. It is also possible to provide simple branch conduits instead of the annular lines 44 and 60.

The foregoing relates to preferred exemplary embodiments of the invention, it being understood that other variants and embodiments thereof are possible within the spirit and scope of the invention, the latter being defined by the appended claims.

We claim:

1. A method for operating an internal combustion engine, in particular with direct injection, in which a first fuel pump (14) delivers fuel from a fuel tank (12) and in which at least a part of the delivered fuel travels on via at least one inlet valve (42) into at least one working chamber (40) of a second fuel pump (20) embodied as a positive-displacement pump, which delivers the fuel to a fuel accumulation line (24), the method comprising influencing the relative opening duration (104) of the inlet valve (42) to thereby change the fuel quantity delivered by the second fuel pump (20).

2. The method according to claim 1, wherein the relative opening duration (104) of the inlet valve (42) is hydraulically influenced.

3. The method according to claim 2, wherein the relative opening duration (104) of the inlet valve (42) is influenced by changing a control pressure that acts on a control surface (91) of a valve element (80) of the inlet valve (42).

4. The method according to claim 1, wherein in order to achieve a zero-delivery, the inlet valve (42) is open during the entire delivery stroke.

5. The method according to claim 3, wherein in order to achieve a zero-delivery, the inlet valve (42) is open during the entire delivery stroke.

6. The method according to claim 1, wherein the desired driving torque of the engine is at least indirectly used to determine a reference opening duration of the inlet valve (42) of the second fuel pump (14) and/or a reference control pressure.

7. The method according to claim 3, wherein the desired driving torque of the engine is at least indirectly used to determine a reference opening duration of the inlet valve (42) of the second fuel pump (14) and/or a reference control pressure.

8. The method according to claim 4, wherein the desired driving torque of the engine is at least indirectly used to determine a reference opening duration of the inlet valve (42) of the second fuel pump (14) and/or a reference control pressure.

9. A computer program suitable for executing the method according to claim 1, when the program is run on a computer.

10. A computer program suitable for executing the method according to claim 6, when the program is run on a computer.

11. The computer program according to claim 9, wherein the program is stored in a memory, in particular a flash memory.

12. A control and/or regulating unit (54) for controlling and/or regulating at least one function of an internal combustion engine, the unit (54) comprising computer program according to claim 9.

13. A control and/or regulating unit (54) for controlling and/or regulating at least one function of an internal combustion engine, the unit (54) comprising computer program according to claim 11.

14. A fuel system (10) for an internal combustion engine, in particular with direct injection, comprising
a fuel tank (12),
a first fuel pump (14) that delivers from the fuel tank (12),
a second fuel pump (20) embodied as a positive-displacement pump with at least one working chamber (40),
at least one inlet valve (42) connecting on the inlet side of said working chamber (40) to the first fuel pump (14)

11. The computer program according to claim 9, wherein the program is stored in a memory, in particular a flash memory.

12. A control and/or regulating unit (54) for controlling and/or regulating at least one function of an internal combustion engine, the unit (54) comprising computer program according to claim 9.

13. A control and/or regulating unit (54) for controlling and/or regulating at least one function of an internal combustion engine, the unit (54) comprising computer program according to claim 11.

14. A fuel system (10) for an internal combustion engine, in particular with direct injection, comprising
a fuel tank (12),
a first fuel pump (14) that delivers from the fuel tank (12),
a second fuel pump (20) embodied as a positive-displacement pump with at least one working chamber (40),
at least one inlet valve (42) connecting the inlet side of said working chamber (40) to the first fuel pump (14)
a fuel accumulation line (24) connected to the outlet the side of the working chamber (40), and
an influencing device (74) operable to influence the relative opening duration (104) of the inlet valve (42).

15. The fuel system (10) according to claim 14, wherein the inlet valve is embodied as a prestressed check valve (42) and the influencing device (74) includes an actuating section (86) that is connected to a valve element (80) of the check valve (42).

16. The fuel system (10) according to claim 15, wherein the influencing device (74) comprises a control pressure line (50), a pressure adjusting device (52, 64, 66) that can adjust the pressure in the control pressure line (50), and a control chamber (90) connected to the control pressure line (50), and wherein the actuating section (86) of the valve element (80) of the inlet valve (42) has a control surface (91) that partially defines the control chamber (90).

17. The fuel system (10) according to claim 16, wherein the pressure adjusting device comprises an electrically adjustable metering valve (52), a return line (64) that branches from the control pressure line (50) between the metering valve (52) and the control chamber (90), and a flow throttle (66) that is disposed in the return line (64).

18. The fuel system (10) according to claim 11, wherein the influencing device (74) comprises a fluid reservoir (106), which is disposed upstream of the metering valve (52) and is connected to the control pressure line (50).

19. The fuel system (10) according to claim 18, wherein the fluid reservoir (106) communicates with at least one hydraulically actuated injector (26) in such a way that the reservoir is supplied by the cutoff fluid from the injector.

20. The fuel system (10) according to claim 11, wherein the control surface (91) on the actuating section (86) for the valve element (8) of the inlet valve (42) is larger than the effective surface area (81) of the valve element (80) and that the control pressure line (50) is connected to the outlet of the first fuel pump (14).
